(19) United States
(12) Patent Application Publication
(10) Pub. No.: US 2019/0311586 A1
(43) Pub. Date: Oct. 10, 2019

(54) SAFE SHIELDING

(71) Applicant: FireKing Security Products, LLC., New Albany, IN (US)

(72) Inventors: Michael J. Smith, Scottsburg, IN (US); Joshua Costley, Indianapolis, IN (US); Paul Joseph Boggs, Otisco, IN (US); Chuck Kuhn, Clarksville, IN (US)

(21) Appl. No.: 16/378,692

(22) Filed: Apr. 9, 2019

Related U.S. Application Data
(60) Provisional application No. 62/671,446, filed on May 15, 2018.
(60) Provisional application No. 62/654,805, filed on Apr. 9, 2018.

(51) Int. Cl. G07F 19/00

(52) U.S. Cl. CPC G07F 19/205

(57) ABSTRACT

A shield is contemplated for use in protecting safes, automatic teller machines (ATMs), vending machines and/or virtually any other apparatus or device utilizing a bill validator, a note handler or other processing device from debris, liquids and other contaminants interfering with capabilities needed to facilitate importing and/or exporting notes, bills, currency, paper or other items.

### CROSS-REFERENCE TO RELATED APPLICATIONS

This application claims the benefit of U.S. provisional Application No. 62/654,805 filed Apr. 9, 2018 and U.S. provisional Application No. 62/671,446 filed May 15, 2018, the disclosures of which are incorporated their entireties by reference herein.

### TECHNICAL FIELD

The present invention relates to shielding safes, automatic teller machines (ATMs), vending machines and/or virtually any other apparatus or device utilizing a bill validator, note handler or other processing device to facilitate importing and/or exporting of notes, bills, currency, paper or other items for processing and/or storing.

### BACKGROUND

Validators, handlers and/or other processing/transport mechanisms utilized to facilitate import/export of notes, bills, currency, paper or other items may experience operational degradation when subjected over time to debris, liquids, fluids or other elements. Safes or other note handling apparatuses included within convenience stores or other locations where an attendant may be processing paper bills while also engaging with customers purchasing objects and/or liquids may be particularly susceptible to contamination resulting from repeatedly being exposed to debris dropped from above, such as when debris drops or drips off of a countertop used at the point-of-sale (POS). While not necessarily limited to any particular environment, one non-limiting aspect of the present invention contemplates shielding validators, handlers and/or other bill, currency, paper or other item processing/transport mechanisms included on safes or other structures used in convenience stores or at other POS installations from debris, liquids, etc., including shielding such devices from objects and/or liquids dropping from above off of a countertop or other surface.

### BRIEF DESCRIPTION OF THE DRAWINGS

FIG. 1 illustrates a system for securing and/or processing notes, bills, currency, paper or other items in accordance with one non-limiting aspect of the present invention.

FIG. 2 illustrates a sectional view A-A of the system in accordance with one non-limiting aspect of the present invention.

FIG. 3 illustrates the sectional view A-A with the first shield removed in accordance with one non-limiting aspect of the present invention.

FIGS. 4-6 illustrate the first shield in accordance with one non-limiting aspect of the present invention.

FIG. 7 illustrates an assembly diagram in accordance with one non-limiting aspect of the present invention.

FIGS. 8-9 illustrate a system for securing and/or processing notes, bills, currency, paper or other items in accordance with one non-limiting aspect of the present invention.

FIGS. 10-12 illustrate additional views of a shield in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

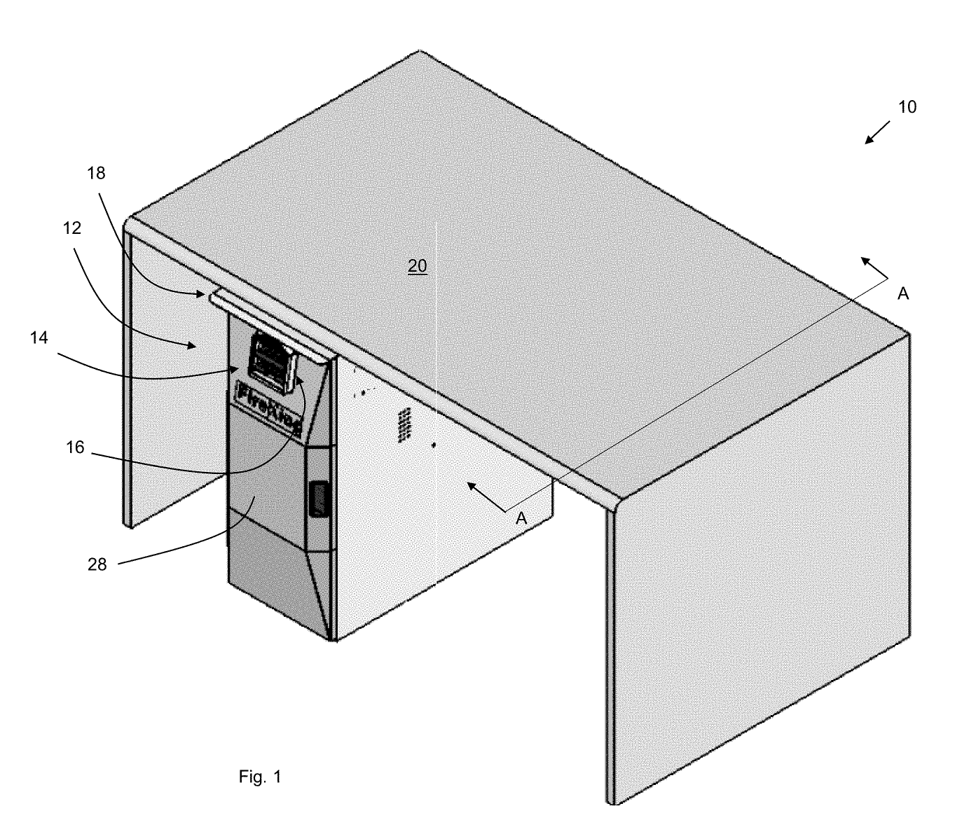

FIG. 1 illustrates a system 10 for securing and/or processing notes, bills, currency, paper or other items in accordance with one non-limiting aspect of the present invention. The system 10 may include a safe 12 having a bill validator 14 to facilitate processing of virtually any article, particularly paper bills or other tangible, pecuniary representations having a need to be verified, sorted, stored, etc., which for exemplary non-limiting purposes may be illustratively referred to as paper bills. The bill validator 14 may be any suitable device with componentry sufficient to facilitate processing paper bills either for storage or return to a user, such as in accordance with the bill validator described in U.S. patent application Ser. No. 10/903,119, entitled Apparatus Having A Bill Validator And A Method Of Servicing The Apparatus, the disclosure of which is hereby incorporated by reference in its entirety herein. The system 10 may be utilized in any environment and is predominately described for exemplary non-limiting purposes with respect to use as a point-of-sale (POS) system or in another location whereby cashiers or other attendants may be interacting with customers to facilitate performing transactions, such as in the manner described in U.S. patent application Ser. No. 14/532,145, entitled Note Verify, the disclosure of which is hereby incorporated by reference in its entirety herein.

The interactions between customer and attendant when making a purchase, such as at a convenience store where an individual may be purchasing solid products and/or liquids, or when included on an arcade game or other counsel where users may placing beverages or other items thereon while in use, may cause objects, liquids and other debris to fall from above or otherwise interact with the bill validator 14 in a manner capable of potentially damaging its operation. One non-limiting aspect of the present invention contemplates shielding the bill validator 14 from debris dropping from above or otherwise impacting operation. A first shield 16 contemplated by the present invention, which may be referred to as a v-shield 16, may be used to create an outcropping around an opening on a front of the safe to protect the bill validator 14 from debris. A second shield 18 contemplated by the present invention, which may be referred to as a drip plate 18, may be used to create an overhang on a countertop or other ledge 20 disposed above the safe 12 to prevent debris from falling down onto the bill validator 14. While use of both shields 16, 18 is described for exemplary purposes, the present invention fully contemplates its use and application in shielding the bill validator 14 and/or the safe 12 from debris using either one of the shields 16, 18 independently.

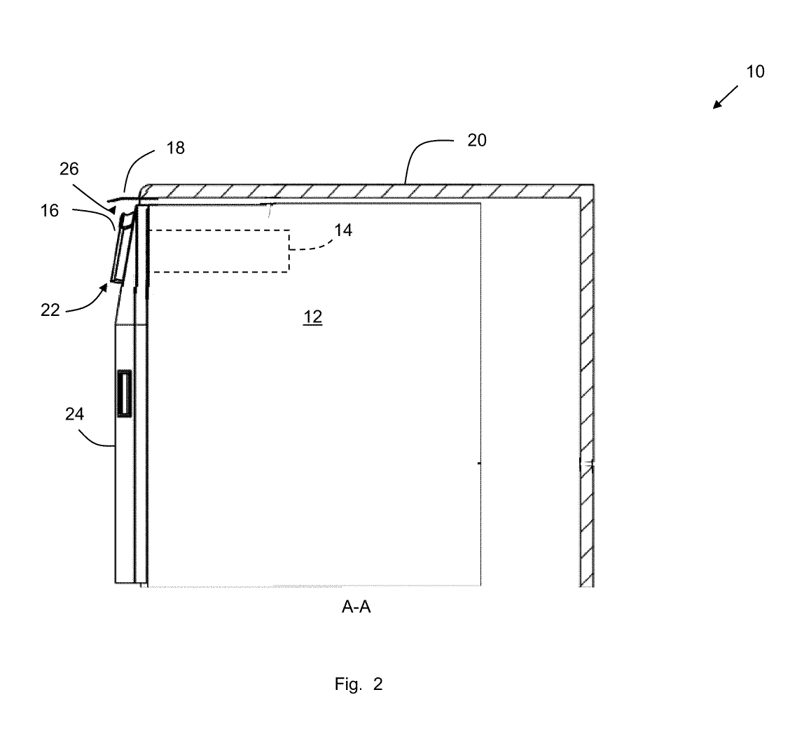

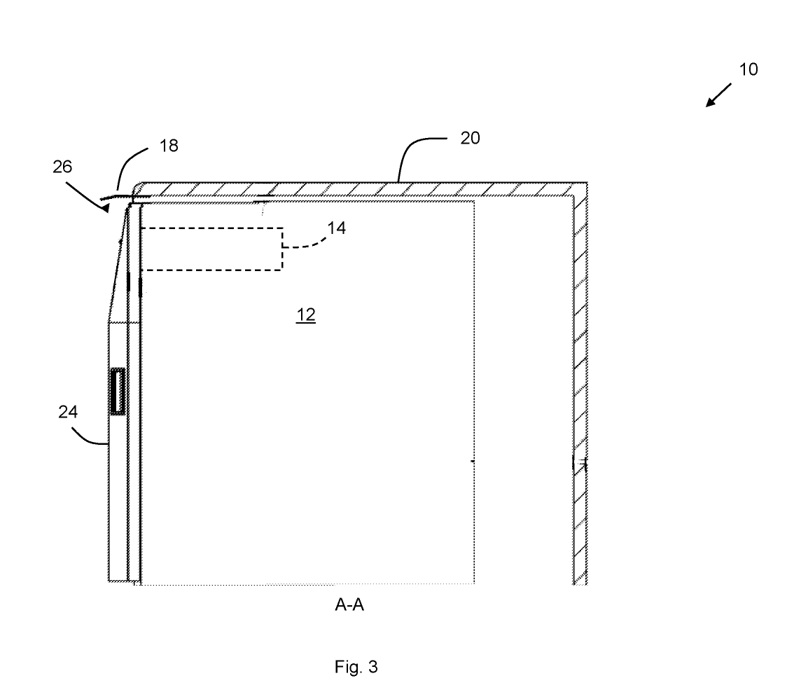

FIG. 2 illustrates a sectional view A-A of the system in accordance with one non-limiting aspect of the present invention. The view illustrates an outcropping 22 of the v-shield 16 generally corresponding with material extending forwardly beyond a front 24 of the safe 12 to surround an opening to the bill validator 14. The v-shield 16 is illustrated for exemplary purposes as entirely surrounding the opening as the present invention fully contemplates the shield 16 surrounding or being positioned to generate the outcropping 22 around less than an entirety of the opening and/or having other shapes or sizes to correspond with differently sized access to the bill validator 14. The view also illustrates the drip shield 18 creating an overhang 26 optionally with a rearward end being parallel with the countertop/ledge and a forward end sloping downwardly. The overhang 26 may be sufficient to extend beyond a forward end of the v-shield 16 in the illustrated manner and/or beyond another feature of the safe 12 desired for protection. FIG. 3 illustrates the sectional view A-A width of the v-shield 16 removed in accordance with one non-limiting aspect of the present invention. With the v-shield 16 removed, the componentry comprising the bill validator 14 may be seen as recessed behind the front 24 of the safe 12 such that an exposed portion of the bill validator may be rearward of the front 24 of the safe 12.

The positioning of the bill validator 14 is illustrated for exemplary non-limiting purposes as the bill validator 14 may protrude beyond the front face 24 of the safe 12 or otherwise be positioned so as to require the first and/or second shields 16, 18 to be sized or shaped differently to provide the desired protection. Returning to FIG. 1, a cover 28 may be included on the safe 12 to define the front 24 of the safe, such as with the illustrated sloping exterior having an actuatable door and/or as an optional component capable of being removed when undesired. Bill validators may be available in virtually any size and formation whereby shielding such validators from debris with the first and second shields 16, 18 contemplated by the present invention may require some deviation from the illustrated embodiments. While the present invention contemplates the first and second shields 16, 18 being included at the time of manufacture or integrated with the safe, one aspect of the present invention contemplates the shields 16, 18 being aftermarket components or components added after manufacture of the safe, such as to facilitate use with previously deployed bill validators suffering from repeated exposure, and/or optionally as independent structures capable of protecting the bill validator without being connected directly to the bill validator or included as part of the bill validator.

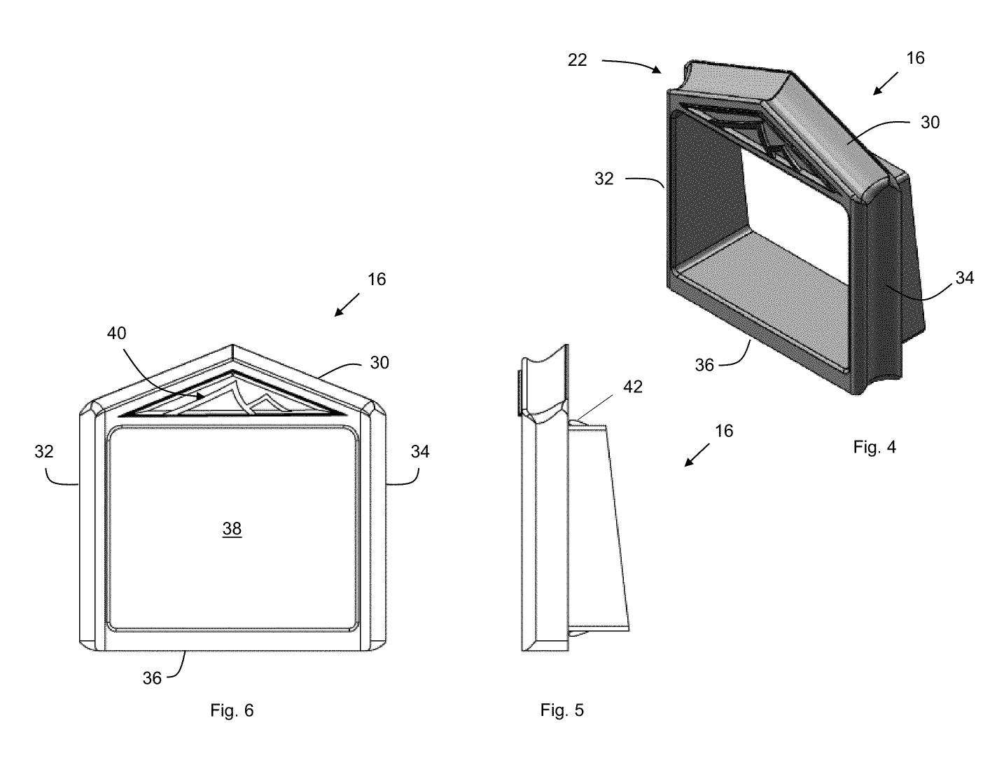

FIGS. 4-6 illustrate the v-shield 16 in accordance with one non-limiting aspect of the present invention. The v-shield 16 may be shaped to provide the outcropping 22 around an opening to the bill validator 14, which may be generally defined as including a top 30, opposed sides 32, 34 and a bottom 36. A center 38 may be open or hollow to facilitate access to the bill validator 14 with inner sides extending rearwardly beyond the front 24 of the safe 12 to surround part of the bill validator 14 in order to allow user access to the bill validator 14. The opening 38 may be sufficient to permit the bill validator 14 to slide therethrough for servicing or in some case it may be undesired or unreasonable for the opening 28 to accommodate removal of the bill validator 14 therethrough. The outcropping 22 may be defined as the portion of the v-shield 16 extending forwardly beyond the front 24 of the safe 12 such that, as illustrated, part of the v-shield 16 forward of the front 24 may be larger than part of the v-shield 16 rearward of the front 24. An outer middle of the top 30 and an outer middle of the opposed sides 32, 34 may include a concave shape or other coordinated feature to facilitate channeling debris away from the bill validator 14 and/or to provide a uniform appearance. The top 30 may be sloped laterally from a center to provide a peak 40 relative to the center opening 38, such as to facilitate directing debris away from the opening 38 and/or to provide an area for signage or other aesthetics. An attachment element 42 may be included on one or more of the inner portions to facilitate attaching the v-shield 16 to the front 24 of the safe 12.

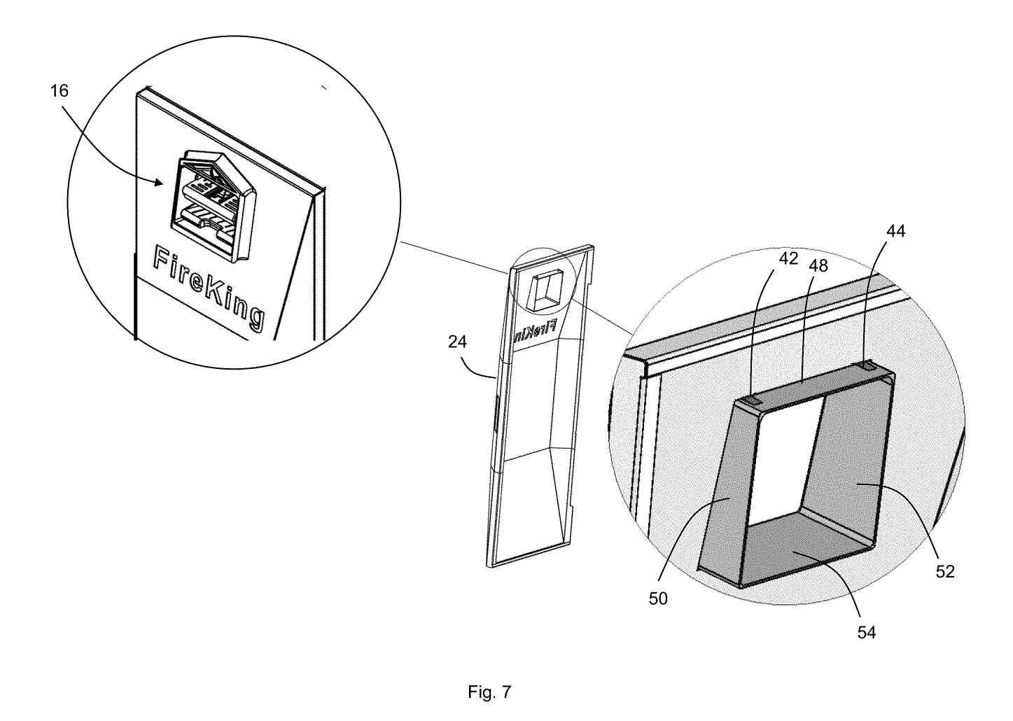

FIG. 7 illustrates an assembly diagram of the v-shield 16 in accordance with one non-limiting aspect of the present invention. The diagram illustrates use of a first attachment element 42 and a second attachment element 44 to facilitate attaching the v-shield 12 to the front 24 as number of attachment elements may be used. The attachment elements 42, 44 may be snap locks providing a ramped surface to be inserted within the opening of the safe, and once sufficiently inserted, to engage the opening with sufficient force to retain the v-shield 16 in the illustrated positioning. The attachment elements 42, 44 may enable the v-shield 16 to be attached to the safe 12 after manufacture and in a removable manner whereby the v-shield 16 may be subsequently removed from the opening with disengagement of the ramped surface. The v-shield 16 may be shaped to match a slope of the front face 24 such that the outcropping 22 may be parallel to the corresponding portion of the front face 24 as in the illustrated manner and/or the v-shield 16 may be shaped differently to provide more of an outcropping, such as by being perpendicular to the ground. Inner portions 48, 50, 52, 54 may extend rearwardly into the safe 12 at different lengths depending on the components of the bill validator 14 and/or other elements within an interior of the safe 12. It may be advantageous for the inner portions 48, 50, 52, 54 to extend as far as possible into an interior of the safe 12 to further protect against debris entering the safe through the opening 38. The inner portions 48, 50, 52, 54 are shown to be parallel to the ground but may be sloped inwardly or in another manner to generate angles or slopes to further limit the passage of debris, option without contacting the bill validator 14.

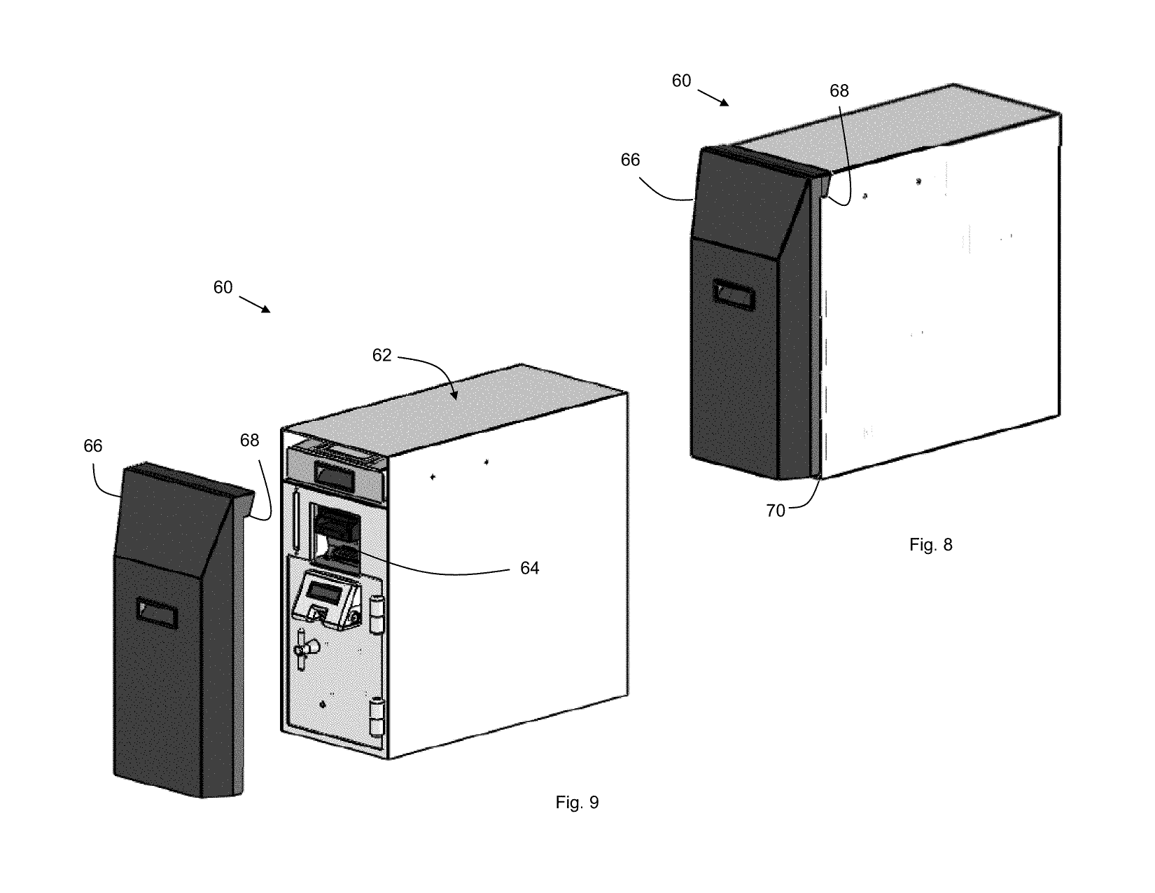

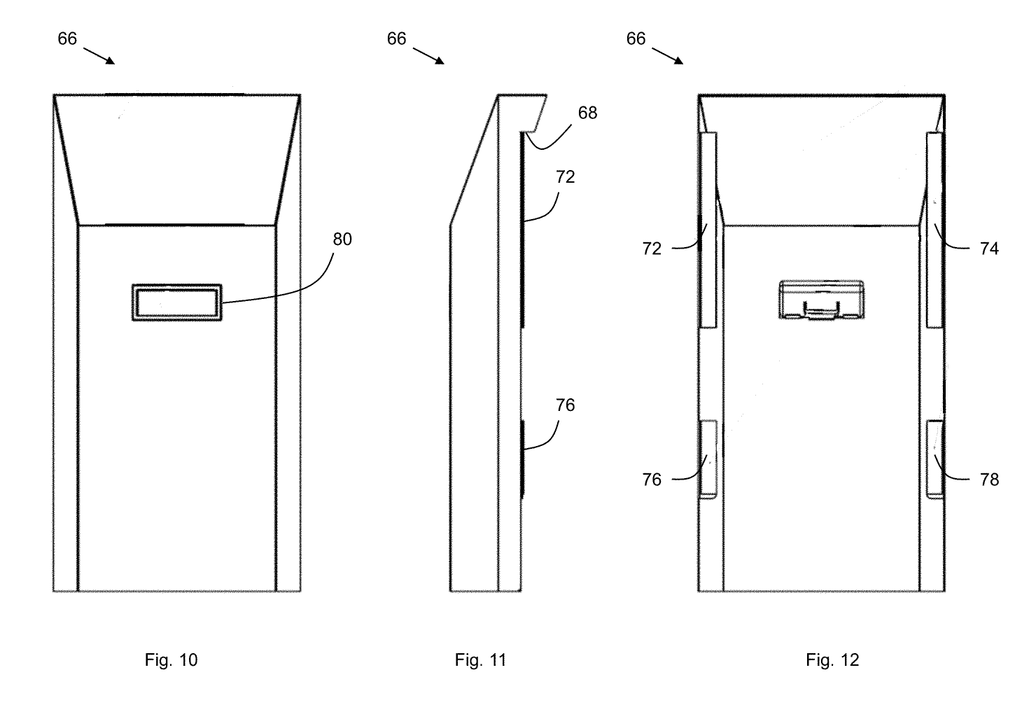

FIGS. 8-9 illustrate a system 60 for securing and/or processing notes, bills, currency, paper or other items in accordance with one non-limiting aspect of the present invention. The system 60 may include a safe 62 having a bill validator 64 whereby the bill validator 64 and other features of the safe 62 may be protected with a third shield 66, which may be referred to as a slap fit shield. The third shield 66 may be shaped to conceal just the bill validator 64 and/or in the illustrated manner to conceal an entirety of a front of the safe 62. The third shield 66 may include a top portion 68 shaped to rest on top of the safe 62 with a bottom portion resting on the ground and/or in the illustrated manner above a bottom 70 of the safe 62. The top portion 68 may overlap a top of the safe 62 for support and to protect against debris dropping from above onto the bill validator. FIGS. 10-12 illustrate additional views of the third shield 66 in accordance with one non-limiting aspect of the present invention. The third shield 66 may include a plurality of magnets 72, 74, 76, 78 or other attachment features to facilitate removably attaching to the safe 62. A handle 80 may be included to ease removal of the third shield 60 from the safe 62, which may be required each time use of the bill validator 64 is desired or other access to the safe 62 is needed due to the third shield 66 concealing an entirety of the front of the safe 62. The third shield 66 may include a shape or aesthetics to camouflage the safe 62 or to otherwise create an appearance that the safe 62 is another object, such as a filing cabinet, box, etc.

As supported above, one non-limiting aspect of the present invention contemplates a shielding system where a drip shield attached to an underside of a countertop deflects liquids, debris, etc. from a device positioned under the countertop having a validator, handler and/or other processing/transport mechanism; a cover for concealing an opening to a bill validator or an entirety of a front of the device having the bill validator; and/or a validator shield (v-shield) attached to the device proximate the validator, handler and/or other processing/transport mechanism. The drip shield, the cover and the validator shield may operate in concert to provide a shielding system, however, the present invention is not necessarily so limited and fully contemplates using each independently to facilitate shielding validators, handlers and/or other processing/transport mechanisms from debris, liquids, etc. encountered during usage of an attendant device. One non-limiting aspect of the present invention contemplates shielding the validators and/or other features described in U.S. application Ser. Nos. 14/532,145 and 15/297,520, the disclosures of which are hereby incorporated by reference in their entireties herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for protecting a bill validator from debris when exposed through a front of a safe, the system comprising:
a shield shaped to protect an exposed portion of the bill validator from debris.

2. The system of claim 1 wherein the shield connects to an opening in the front of the safe having the exposed portion, the shield being shaped to produce an outcropping proximate at least a top portion of the opening to protect the bill validator from debris dropping from above.

3. The system of claim 2 wherein a top of the shield is shaped to define a portion of the outcropping above the top portion.

4. The system of claim 3 wherein the top is shaped to slope laterally downward relative to a center of the opening.

5. The system of claim 3 wherein the shield includes:
opposed sides shaped to extend vertically downward from the top to define a portion of the outcropping proximate corresponding side portions of the opening; and
a bottom shaped to extend horizontally between the opposed sides to define a portion of the outcropping below the opening such the shield surrounds an entirety of the opening without contacting the bill validator.

6. The system of claim 5 wherein an outer middle of the top and an outer middle of each opposed side has matching concave shapes to channel away debris.

7. The system of claim 5 wherein inner portions of each of the top, the opposed sides and the bottom extend rearwardly beyond the front into an interior of the safe.

8. The system of claim 7 wherein one or more of the inner portions includes an attachment element for securing the shield to the opening.

9. The system of claim 8 wherein the attachment element is a snap lock shaped to engage a rearward side of the opening when the shield is sufficiently inserted therethrough.

10. The system of claim 2 further comprising a drip plate attached to a countertop or a ledge disposed above the safe, the drip plate being shaped to extend beyond a forward end of the shield to protect the bill validator from debris dropping from above.

11. The system of claim 1 wherein the shield connects to a countertop or a ledge disposed above the safe, the shield being shaped to extend beyond the front of the safe to protect the bill validator from debris dropping from above.

12. The system of claim 11 wherein a width of the shield is greater than a width of the exposed portion.

13. The system of claim 12 wherein the width is equal to or greater than a width of the safe.

14. The system of claim 11 wherein a rearward end of the shield is parallel with a bottom side of the countertop or the ledge and a forward end of the shield slopes downwardly from the bottom side.

15. The system of claim 1 wherein the shield is a cover removably attached to the safe with magnets or other attachment sufficient to permit repeated removal, the cover being shaped to conceal at least an entirety of the exposed portion.

16. The system of claim 15 wherein the cover is shaped to conceal an entirety of the front and to include a handle, the handle enabling a user to lift the cover off of the safe to access the bill validator.

17. The system of claim 16 wherein a top of the cover is shaped to rest on a top side of the safe and a bottom of the cover is shaped to be offset above a bottom side of the outer housing.

18. A system for protecting a bill validator from debris when included as part of a safe deposed below a ledge, the system comprising:
a first shield attached to an opening on a front of the safe having the bill validator, the first shield being shaped to protect the bill validator with an outcropping; and
a second shield attached to the ledge, the second shield being shaped to extend beyond a forward end of the first shield to protect the bill validator with an overhang.

19. A shield for protecting a bill validator from debris when included as part of a safe, the shield comprising:
a top shaped to protect a top portion of an opening on the safe having the bill validator;
opposed sides shaped to protect opposed sides of the opening;
a bottom shaped to extend between the opposed sides below the opening; and
one or more of attachment elements for securing the shield to the opening.

20. The shield of claim 19 wherein:
outer middle of the top and an outer middle of each opposed side are concave shaped to channel away debris; and
each attachment element is a snap lock shaped to engage a rearward side of the opening.
